(19) United States
(12) Patent Application Publication
(10) Pub. No.: US 2014/0267207 A1
(43) Pub. Date: Sep. 18, 2014

(54) METHOD AND APPARATUS FOR VERIFYING DISPLAY ELEMENT STATE

(71) Applicant: QUALCOMM MEMS TECHNOLOGIES, INC., San Diego, CA (US)

(72) Inventors: Didier H. Farenc, San Diego, CA (US); Gol Mulbe Nadiguebe, La Jolla, CA (US); Nada Vukovic-Radic, San Diego, CA (US)

(73) Assignee: QUALCOMM MEMS Technologies, Inc., San Diego, CA (US)

(21) Appl. No.: 13/831,303

(22) Filed: Mar. 14, 2013

(51) Int. Cl. G09G 3/20

(52) U.S. Cl. CPC G09G 3/20
USPC 345/211

(57) ABSTRACT

This disclosure provides systems, methods and apparatus, including computer programs encoded on computer storage media, for verifying actuation of an IMOD display element. In one aspect, a display apparatus is provided. The display apparatus includes an interferometric modulator (IMOD) display element coupled to a row electrode and coupled to a column electrode. The display apparatus further includes a driver circuit configured to apply voltage waveforms corresponding to image data to the row and column electrodes coupled to the IMOD display element to control actuation of the IMOD display element. The display apparatus further includes a detection circuit configured to detect actuation of the IMOD display element using the voltage waveforms.

### TECHNICAL FIELD

This disclosure relates to verifying display element state when driving electromechanical display devices.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

### SUMMARY

The systems, methods and devices of this disclosure each have several innovative aspects, no single one of which is solely responsible for the desirable attributes disclosed herein.

One innovative aspect of the subject matter described in this disclosure can be implemented in a display apparatus. In this implementation, the display apparatus may include an array of display elements formed at the intersections of a plurality of column electrodes and a plurality of row electrodes, a column driver circuit configured to selectively apply at least first and second column voltages corresponding to image data to the column electrodes, a row driver circuit configured to apply write pulses to the row electrodes to sequentially set rows of the array to states based at least in part on the voltages selectively applied to the column electrodes, and one or more switches each having an input terminal coupled to a column electrode, a first output terminal coupled to an output of the column driver circuit, and a second output terminal coupled to the first input of an integrator. The display apparatus may be configured to selectively apply column voltages to the column electrodes corresponding to image data to be displayed while each of the one or more switches have their input terminal coupled to their first output terminal so that the column electrodes are coupled to outputs of the column driver circuit. The apparatus may be further configured to set the first inputs of the integrators to one of the at least first and second column voltages, connect the input terminals of the one or more switches to the second output terminals of the one or more switches without changing the voltages on the column electrodes, and apply a write pulse to a row electrode to set the state of the display elements in accordance with the image data. In addition, the display apparatus may be configured to integrate a current in the column electrode produced by a trailing edge of the write pulse, and determine a state of one or more display elements at the time of the trailing edge of the write pulse based at least in part on the current.

In some implementations, the display apparatus can include a leakage detection circuit configured to detect an amount of leakage current in the column electrode at a time prior to the leading edge of the write pulse.

Another innovative aspect of the subject matter described in this disclosure can be implemented in a method of detecting the state of a display element. The method may include applying a column voltage with a column driver circuit to a column electrode coupled to the display element according to image data generated for display, uncoupling the column driver circuit from the column electrode, maintaining the column voltage with a current detection circuit, applying a write waveform including a leading edge and a trailing edge with a row driver circuit to a row electrode coupled to the display element, and detecting the state of the display element at the trailing edge of the write waveform with the current detection circuit.

Another innovative aspect of the subject matter described in this disclosure can be implemented in a display apparatus including means for applying a column voltage with a column driver circuit to a column electrode coupled to a display element according to image data generated for display, means for uncoupling the column driver circuit from the column electrode, means for maintaining the column voltage with a current detection circuit, means for applying a write waveform including a leading edge and a trailing edge with a row driver circuit to a row electrode coupled to the display element, and means for detecting the state of the display element at the trailing edge of the write waveform with the current detection circuit.

Details of one or more implementations of the subject matter described in this disclosure are set forth in the accompanying drawings and the description below. Although the examples provided in this disclosure are primarily described in terms of EMS and MEMS-based displays the concepts provided herein may apply to other types of displays such as liquid crystal displays, organic light-emitting diode (“OLED”) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is an isometric view illustration depicting two adjacent interferometric modulator (IMOD) display elements in a series or array of display elements of an IMOD display device.

FIG. 2 is a system block diagram illustrating an electronic device incorporating an IMOD-based display including a three element by three element array of IMOD display elements.

FIG. 3 is a graph illustrating movable reflective layer position versus applied voltage for an IMOD display element.

FIG. 4 is a table illustrating various states of an IMOD display element when various common and segment voltages are applied.

FIG. 5A is an illustration of a frame of display data in a three element by three element array of IMOD display elements displaying an image.

FIG. 5B is a timing diagram for common and segment signals that may be used to write data to the display elements illustrated in FIG. 5A.

FIGS. 6A and 6B are schematic exploded partial perspective views of a portion of an electromechanical systems (EMS) package including an array of EMS elements and a backplate.

FIG. 7 is a schematic diagram of a circuit for detecting actuation of an IMOD display element.

FIG. 8 is a schematic diagram of an implementation of the circuit of FIG. 7 for detecting actuation of an IMOD display element.

FIG. 9 is a diagram showing voltage waveforms that may be applied in the implementation shown in FIG. 8 for detecting actuation of an IMOD display element.

FIG. 10 is a schematic diagram of a circuit for detecting actuation of one or more IMOD display elements in an array of IMOD display elements.

FIG. 11 is a flowchart of an implementation of a method of detecting actuation of an IMOD display element.

FIG. 12 is flowchart of another implementation of a method of detecting actuation of one or more IMOD display elements.

FIGS. 13A and 13B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (UPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

As further described below, image data may be written to an IMOD based display to selectively actuate individual IMOD display elements to form an image. Due to various operating conditions, certain addressed IMOD display elements may fail to actuate when driven. Accordingly, it may be desirable to be able to detect whether the IMOD display elements are actuated to verify the image data written to the array. Actuation voltages may be dependent on dynamic run-time conditions. Implementations described herein are directed to detecting actuation of IMOD display elements as image data is being written to a display array.

In one implementation, a detection circuit may be configured to detect actuation of an IMOD display element using voltage waveforms applied to a row and a column electrode coupled to the IMOD display element according to image data being written. For example, the detection circuit may be configured to use a write voltage waveform that controls actuation of display elements according to image data to determine whether an IMOD display element is actuated. In one implementation, the detection circuit may be configured to measure a current induced on a column electrode in response to a change in the write voltage waveform on the row electrode. The induced current may be a function of the capacitance of the IMOD display element that is used to determine if the IMOD display element is in an actuated state. In one implementation, the detection circuit may include an integrator circuit configured to integrate a current induced on the addressed column electrode to measure the capacitance to determine actuation.

Particular implementations of the subject matter described in this disclosure can be implemented to realize one or more of the following potential advantages. For example, implementations described herein may allow for detecting actuation of IMOD display elements as image data is being written to the display. This may allow for correction of actuation errors as the image data is being written. In one aspect, this may avoid relying solely on calibration testing. Moreover, this may allow for dynamic adjustment of display driver voltages based on changes in actuation voltages that may be dependent on dynamic run-time conditions and undetected in an calibration period.

An example of a suitable EMS or MEMS device or apparatus, to which the described implementations may apply, is a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

FIG. 1 is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 1 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 1, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 1 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 1, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 1. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 is a system block diagram illustrating an electronic device incorporating an IMOD-based display including a three element by three element array of IMOD display elements. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example a display array or panel 30. The cross section of the IMOD display device illustrated in FIG. 1 is shown by the lines 1-1 in FIG. 2. Although FIG. 2 illustrates a 3×3 array of IMOD display elements for the sake of clarity, the display array 30 may contain a very large number of IMOD display elements, and may have a different number of IMOD display elements in rows than in columns, and vice versa.

FIG. 3 is a graph illustrating movable reflective layer position versus applied voltage for an IMOD display element. For IMODs, the row/column (i.e., common/segment) write procedure may take advantage of a hysteresis property of the display elements as illustrated in FIG. 3. An IMOD display element may use, in one example implementation, about a 10-volt potential difference to cause the movable reflective layer, or mirror, to change from the relaxed state to the actuated state. When the voltage is reduced from that value, the movable reflective layer maintains its state as the voltage drops back below, in this example, 10 volts, however, the movable reflective layer does not relax completely until the voltage drops below 2 volts. Thus, a range of voltage, approximately 3-7 volts, in the example of FIG. 3, exists where there is a window of applied voltage within which the element is stable in either the relaxed or actuated state. This is referred to herein as the “hysteresis window” or “stability window.” For a display array 30 having the hysteresis characteristics of FIG. 3, the row/column write procedure can be designed to address one or more rows at a time. Thus, in this example, during the addressing of a given row, display elements that are to be actuated in the addressed row can be exposed to a voltage difference of about 10 volts, and display elements that are to be relaxed can be exposed to a voltage difference of near zero volts. After addressing, the display elements can be exposed to a steady state or bias voltage difference of approximately 5 volts in this example, such that they remain in the previously strobed, or written, state. In this example, after being addressed, each display element sees a potential difference within the “stability window” of about 3-7 volts. This hysteresis property feature enables the IMOD display element design to remain stable in either an actuated or relaxed pre-existing state under the same applied voltage conditions. Since each IMOD display element, whether in the actuated or relaxed state, can serve as a capacitor formed by the fixed and moving reflective layers, this stable state can be held at a steady voltage within the hysteresis window without substantially consuming or losing power. Moreover, essentially little or no current flows into the display element if the applied voltage potential remains substantially fixed.

In some implementations, a frame of an image may be created by applying data signals in the form of “segment” voltages along the set of column electrodes, in accordance with the desired change (if any) to the state of the display elements in a given row. Each row of the array can be addressed in turn, such that the frame is written one row at a time. To write the desired data to the display elements in a first row, segment voltages corresponding to the desired state of the display elements in the first row can be applied on the column electrodes, and a first row pulse in the form of a specific “common” voltage or signal can be applied to the first row electrode. The set of segment voltages can then be changed to correspond to the desired change (if any) to the state of the display elements in the second row, and a second common voltage can be applied to the second row electrode. In some implementations, the display elements in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each display element (that is, the potential difference across each display element or pixel) determines the resulting state of each display element. FIG. 4 is a table illustrating various states of an IMOD display element when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

As illustrated in FIG. 4, when a release voltage VC_{REL} is applied along a common line, all IMOD display elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator display elements or pixels (alternatively referred to as a display element or pixel voltage) can be within the relaxation window (see FIG. 3, also referred to as a release window) both when the high segment voltage VS_{H} and the low segment voltage VS_{L} are applied along the corresponding segment line for that display element.

When a hold voltage is applied on a common line, such as a high hold voltage VC_{HOLD}_{_{—}}_{H} or a low hold voltage VC_{HOLD}_{_{—}}_{L}, the state of the IMOD display element along that common line will remain constant. For example, a relaxed IMOD display element will remain in a relaxed position, and an actuated IMOD display element will remain in an actuated position. The hold voltages can be selected such that the display element voltage will remain within a stability window both when the high segment voltage VS_{H} and the low segment voltage VS_{L} are applied along the corresponding segment line. Thus, the segment voltage swing in this example is the difference between the high VS_{H} and low segment voltage VS_{L}, and is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that common line by application of segment voltages along the respective segment lines. The segment voltages may be selected such that actuation is dependent upon the segment voltage applied. When an addressing voltage is applied along a common line, application of one segment voltage will result in a display element voltage within a stability window, causing the display element to remain unactuated. In contrast, application of the other segment voltage will result in a display element voltage beyond the stability window, resulting in actuation of the display element. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having substantially no effect (i.e., remaining stable) on the state of the modulator.

In some implementations, hold voltages, address voltages, and segment voltages may be used which produce the same polarity potential difference across the modulators. In some other implementations, signals can be used which alternate the polarity of the potential difference of the modulators from time to time. Alternation of the polarity across the modulators (that is, alternation of the polarity of write procedures) may reduce or inhibit charge accumulation that could occur after repeated write operations of a single polarity.

FIG. 5A is an illustration of a frame of display data in a three element by three element array of IMOD display elements displaying an image. FIG. 5B is a timing diagram for common and segment signals that may be used to write data to the display elements illustrated in FIG. 5A. The actuated IMOD display elements in FIG. 5A, shown by darkened checkered patterns, are in a dark-state, i.e., where a substantial portion of the reflected light is outside of the visible spectrum so as to result in a dark appearance to, for example, a viewer. Each of the unactuated IMOD display elements reflect a color corresponding to their interferometric cavity gap heights. Prior to writing the frame illustrated in FIG. 5A, the display elements can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. In some implementations, the segment voltages applied along segment lines 1, 2 and 3 will have no effect on the state of the IMOD display elements, as none of common lines 1, 2 or 3 are being exposed to voltage levels causing actuation during line time 60a (i.e., VC_{REL}—relax and VC_{HOLD}_{_{—}}_{L}—stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the display element voltage across modulators (1,1) and (1,2) is greater than the high end of the positive stability window (i.e., the voltage differential exceeded a characteristic threshold) of the modulators, and the modulators (1,1) and (1,2) are actuated. Conversely, because a high segment voltage 62 is applied along segment line 3, the display element voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the display element voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state. Then, the voltage on common line 2 transitions back to the low hold voltage 76.

Finally, during the fifth line time 60e, the voltage on common line 1 remains at high hold voltage 72, and the voltage on common line 2 remains at the low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 display element array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the display element voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the line time. Specifically, in implementations in which the release time of a modulator is greater than the actuation time, the release voltage may be applied for longer than a single line time, as depicted in FIG. 5A. In some other implementations, voltages applied along common lines or segment lines may vary to account for variations in the actuation and release voltages of different modulators, such as modulators of different colors.

In some implementations, the packaging of an EMS component or device, such as an IMOD-based display, can include a backplate (alternatively referred to as a backplane, back glass or recessed glass) which can be configured to protect the EMS components from damage (such as from mechanical interference or potentially damaging substances). The backplate also can provide structural support for a wide range of components, including but not limited to driver circuitry, processors, memory, interconnect arrays, vapor barriers, product housing, and the like. In some implementations, the use of a backplate can facilitate integration of components and thereby reduce the volume, weight, and/or manufacturing costs of a portable electronic device.

FIGS. 6A and 6B are schematic exploded partial perspective views of a portion of an EMS package 91 including an array 36 of EMS elements and a backplate 92. FIG. 6A is shown with two corners of the backplate 92 cut away to better illustrate certain portions of the backplate 92, while FIG. 6B is shown without the corners cut away. The EMS array 36 can include a substrate 20, support posts 18, and a movable layer 14. In some implementations, the EMS array 36 can include an array of IMOD display elements with one or more optical stack portions 16 on a transparent substrate, and the movable layer 14 can be implemented as a movable reflective layer.

The backplate 92 can be essentially planar or can have at least one contoured surface (e.g., the backplate 92 can be formed with recesses and/or protrusions). The backplate 92 may be made of any suitable material, whether transparent or opaque, conductive or insulating. Suitable materials for the backplate 92 include, but are not limited to, glass, plastic, ceramics, polymers, laminates, metals, metal foils, Kovar and plated Kovar.

As shown in FIGS. 6A and 6B, the backplate 92 can include one or more backplate components 94a and 94b, which can be partially or wholly embedded in the backplate 92. As can be seen in FIG. 6A, backplate component 94a is embedded in the backplate 92. As can be seen in FIGS. 6A and 6B, backplate component 94b is disposed within a recess 93 formed in a surface of the backplate 92. In some implementations, the backplate components 94a and/or 94b can protrude from a surface of the backplate 92. Although backplate component 94b is disposed on the side of the backplate 92 facing the substrate 20, in other implementations, the backplate components can be disposed on the opposite side of the backplate 92.

The backplate components 94a and/or 94b can include one or more active or passive electrical components, such as transistors, capacitors, inductors, resistors, diodes, switches, and/or integrated circuits (ICs) such as a packaged, standard or discrete IC. Other examples of backplate components that can be used in various implementations include antennas, batteries, and sensors such as electrical, touch, optical, or chemical sensors, or thin-film deposited devices.

In some implementations, the backplate components 94a and/or 94b can be in electrical communication with portions of the EMS array 36. Conductive structures such as traces, bumps, posts, or vias may be formed on one or both of the backplate 92 or the substrate 20 and may contact one another or other conductive components to form electrical connections between the EMS array 36 and the backplate components 94a and/or 94b. For example, FIG. 6B includes one or more conductive vias 96 on the backplate 92 which can be aligned with electrical contacts 98 extending upward from the movable layers 14 within the EMS array 36. In some implementations, the backplate 92 also can include one or more insulating layers that electrically insulate the backplate components 94a and/or 94b from other components of the EMS array 36. In some implementations in which the backplate 92 is formed from vapor-permeable materials, an interior surface of backplate 92 can be coated with a vapor barrier (not shown).

The backplate components 94a and 94b can include one or more desiccants which act to absorb any moisture that may enter the EMS package 91. In some implementations, a desiccant (or other moisture absorbing materials, such as a getter) may be provided separately from any other backplate components, for example as a sheet that is mounted to the backplate 92 (or in a recess formed therein) with adhesive. Alternatively, the desiccant may be integrated into the backplate 92. In some other implementations, the desiccant may be applied directly or indirectly over other backplate components, for example by spray-coating, screen printing, or any other suitable method.

In some implementations, the EMS array 36 and/or the backplate 92 can include mechanical standoffs 97 to maintain a distance between the backplate components and the display elements and thereby prevent mechanical interference between those components. In the implementation illustrated in FIGS. 6A and 6B, the mechanical standoffs 97 are formed as posts protruding from the backplate 92 in alignment with the support posts 18 of the EMS array 36. Alternatively or in addition, mechanical standoffs, such as rails or posts, can be provided along the edges of the EMS package 91.

Although not illustrated in FIGS. 6A and 6B, a seal can be provided which partially or completely encircles the EMS array 36. Together with the backplate 92 and the substrate 20, the seal can form a protective cavity enclosing the EMS array 36. The seal may be a semi-hermetic seal, such as a conventional epoxy-based adhesive. In some other implementations, the seal may be a hermetic seal, such as a thin film metal weld or a glass frit. In some other implementations, the seal may include polyisobutylene (PIB), polyurethane, liquid spin-on glass, solder, polymers, plastics, or other materials. In some implementations, a reinforced sealant can be used to form mechanical standoffs.

In alternate implementations, a seal ring may include an extension of either one or both of the backplate 92 or the substrate 20. For example, the seal ring may include a mechanical extension (not shown) of the backplate 92. In some implementations, the seal ring may include a separate member, such as an O-ring or other annular member.

In some implementations, the EMS array 36 and the backplate 92 are separately formed before being attached or coupled together. For example, the edge of the substrate 20 can be attached and sealed to the edge of the backplate 92 as discussed above. Alternatively, the EMS array 36 and the backplate 92 can be formed and joined together as the EMS package 91. In some other implementations, the EMS package 91 can be fabricated in any other suitable manner, such as by forming components of the backplate 92 over the EMS array 36 by deposition.

After writing image data to an IMOD display array 30, it may be desirable to detect whether the IMOD display elements are actuated to verify the image data written to the array 30. As described above, each IMOD display element 12 may form a capacitive structure. The IMOD display element 12 has a different capacitance when actuated as compared to the capacitance of the IMOD display element 12 when un-actuated. More particularly, the capacitance of an IMOD display element 12 when actuated is larger than the capacitance when un-actuated. For example, the capacitance of an IMOD display element 12 when actuated may be on the order of ten times the capacitance when un-actuated.

Accordingly, sensing values that are a function of the amount of the capacitance of an IMOD display element 12 may be used to determine whether the IMOD display element 12 has been actuated. For example, if the measured capacitance is below a threshold, the IMOD display element 12 may be considered to be in an un-actuated state and vice versa. Testing of actuation may be done during a calibration period when the array 30 is tested to track variation in IMOD display elements and tune driver display voltages. However, it may be desirable to detect actuation and be able to correct actuation as image data is being written to the array 30. For example, as the video rate increases and actuation/write times become shorter, the line impedance of the array 30 may cause one row electrode to actuate at a different rate than another based on their location relative to the edge of the array 30. In other words, actuation voltages may be dependent on dynamic run-time conditions that may not be reflected during a calibration period.

FIG. 7 is a schematic diagram of a circuit for detecting actuation of an IMOD display element 12. The implementation shown in FIG. 7 may be configured to detect actuation of an IMOD display element 12 as image data is being written. As shown in FIG. 7, an IMOD display element 12 is coupled to a row electrode 701 and a column electrode 702. An array driver 22 is further coupled to the IMOD display element 12. The array driver 22 includes a row driver circuit 24 coupled to the row electrode 701 and a column driver circuit 26 coupled to the column electrode 702. The array driver 22 is configured to apply voltage waveforms to the row and column electrodes 701 and 702 to control actuation of the IMOD display element 12. For example, the column driver circuit 26 may be configured to apply an addressing voltage waveform in corresponding to image data to the column electrode 702 while the row driver circuit 24 is configured to apply voltages to trigger actuation of the IMOD display element 12 or maintain the IMOD display element 12 in a selected state as described above.

A detection circuit 704 is configured to detect actuation of the IMOD display element 12 using the voltage waveforms applied by the array driver 22. For example, the detection circuit 704 may be configured to measure capacitance of the IMOD display element 12 using the voltage waveform. The measured capacitance indicates whether the IMOD display element 12 is actuated. According to an implementation, the detection circuit 704 may be configured to measure capacitance by detecting a transient current induced on the column electrode 702 in response to a change in the write voltage waveform applied on the row electrode 701. For example, the row driver circuit 26 may change the voltage applied to the row electrode 701 from a voltage that is used to trigger actuation of the IMOD display element 12 (depending on the voltage level applied to the column electrode 702) to a voltage used to maintain the IMOD display element 12 in a selected state. The induced transient current that results from the change in voltage is a function of the capacitance of the IMOD display element 12. Stated another way, the detection circuit 704 is configured to use the transient current generated on the column electrode 702 when the voltage applied on the row electrode 701 changes from VC_{ADD}_{_{—}}_{H} or VC_{ADD}_{_{—}}_{L} (hereinafter VC_{ADD}) to VC_{HOLD}_{_{—}}_{H} or VC_{HOLD}_{_{—}}_{L} (hereinafter VC_{HOLD}) to measure capacitance. In this way, the write voltage waveform on the row electrode 701 is leveraged to determine capacitance and therefore actuation of the IMOD display element 12.

FIG. 8 is a schematic diagram of an implementation of the circuit of FIG. 7 for detecting actuation of an IMOD display element 12. FIG. 8 shows one example of how the detection circuit 704 of FIG. 7 may be implemented. With reference to FIG. 5B, as shown in line time 60c, after VC_{ADD} is applied to a row electrode 701 to cause selective actuation of an IMOD display element 12, the row driver circuit 24 applies a hold voltage VC_{HOLD}_{_{—}}_{H}. This change in voltage induces a transient current on the column electrode 701 due to the capacitive structure of the IMOD display element 12. As shown in FIG. 8, the detection circuit 704 may include an integrator circuit that includes an operational amplifier 804 with an output coupled to an input of the operational amplifier 804 via a capacitor 808. Another input to the operational amplifier 804 is at a voltage that corresponds to the voltage applied to the column electrode 701 that is represented as a voltage source 806.

The output of the integrator circuit may be provided to a measurement circuit 822 that may include or be configured as, for example, a sense amplifier (not shown) or an analog-to-digital converter (not shown). The output is used to determine the capacitance of the IMOD display element 12. By comparing the results of the output against image data being written, it can be determined whether data has been displayed correctly. The detection circuit 704 further includes an integrator reset switch 802 that triggers the operation of the integrator circuit as is further described below. In addition, a leakage detection circuit 820 is optionally coupled to the detection circuit 704. The leakage detection circuit 820 is configured to detect an amount of leakage current that is used to compensate the output of the integrator circuit to accurately detect the amount of current induced in response to a change from VC_{ADD} to VC_{HOLD}.

FIG. 9 is a diagram showing voltage waveforms that may be applied in the implementation shown in FIG. 8 for detecting actuation of an IMOD display element 12. The row electrode waveform 902 may correspond generally to line time 60 shown in FIG. 5B when, after data is written to the column electrode 702, the row driver circuit 24 applies VC_{ADD} to the row electrode 701 to trigger actuation based on the voltage applied to the column electrode 702. The row driver circuit 24 thereafter reapplies VC_{HOLD} to the row electrode 701 as described above.

Accordingly, an addressing voltage waveform 904 may be applied to the column electrode 702 as shown in FIG. 9 that corresponds to image data. As shown, there may be a preset period 912 when node 812 of switch 816 is coupled to node 810 to connect the column driver circuit output to provide current to column electrodes. As shown by the reset switch waveform 908, in this period, the reset integrator switch 802 is closed and switch 816 is configured such that node 812 is connected to 810. In this state, the column electrode 702 is coupled to the column driver circuit 26. In response to driving addressing data to the column electrode 702, the column electrode 702 is switched to connect to the detection circuit 704 in a column float period. In other words the switch 816 is configured such that node 812 is connected to node 814 (e.g., the column electrode 702 is coupled to the detection circuit 704) while the integrator reset switch 802 is still closed. At this point, the integrator reset switch 802 is closed such that the output of the op-amp is fed back to the column electrode through switches 802 and 816 while the op-amp output is held at the column voltage by the power supply 806 coupled to the positive input of the op-amp so that the same voltage written to the column electrode 702 by the column driver circuit 26 is thereafter applied by the detection circuit 704 to the column electrode 702 of the IMOD display element 12.

The integrator reset switch 802 is thereafter opened during a leakage compensation window 914, and any leakage current may be detected by a leakage detection circuit 820 that is used to compensate the final measurements of the induced current. After the leakage compensation window 914, the integrator reset switch 802 is closed again such that the data image voltages written by the column driver circuit 26 are applied to the column electrode 702. Thereafter, the row driver circuit 24 drives VC_{ADD} to the row electrode 701 to selectively trigger actuation of the IMOD display element 12 based on the voltage applied to the column electrode 702.

Near the end of the period in which VC_{ADD} is applied to the row electrode 701, the integrator reset switch 802 is opened thus triggering operation of the integrator. This triggers the integration window 916. The row driver circuit 24 thereafter applies VC_{HOLD} to the row electrode 701. The change from VC_{ADD} to VC_{HOLD} produces a transient current that causes the output of the integrator to change as a function of the capacitance of the IMOD display element 12. As such, the capacitance of the IMOD display element 12, and therefore its actuation state, can be measured using the voltage waveform used to write image data. If the IMOD display element 12 is not actuated correctly, actions can be triggered to correct the state of the IMOD display element 12. For example, the driver circuit 22 could adjust the voltages applied to the column and row electrodes 701 and 702 and re-apply the adjusted voltages to selectively actuate the IMOD display element 12.

FIGS. 7 and 8 show a detection circuit 704 coupled to a single column electrode 702. However, in accordance with implementations described herein, multiple column electrodes may be coupled to a single detection circuit 704 with a combination of switches that allows the integrator to determine capacitance for multiple groups of IMOD display elements. For example, multiple IMOD display elements may be grouped together and connected to a single detection circuit 704 for measurement and determination of actuated or un-actuated state as a group. In addition, multiple detection circuits may be provided for multiple different groups of IMOD display elements.

FIG. 10 is a schematic diagram of a circuit for detecting actuation of one or more IMOD display elements in an array of IMOD display elements. FIG. 10 shows the detection circuit 704 described above with reference to FIG. 8 selectively coupled to multiple column electrodes 702a, 702b, and 702c. An array driver circuit 22 includes a column driver circuit 26 configured to apply addressing voltage waveforms to column electrodes 702a, 702b, and 702c and a row driver circuit 24 configured to apply write and hold voltages row electrodes 701a, 701b, and 7021c as described above with reference to FIGS. 3-5. Switches 816a, 816b, and 816c selectively couple the column electrodes 702a, 702b, and 702c between the column driver circuit 26 and the detection circuit 704. The detection circuit 704 is configured to detect the state of any one of the IMOD display elements along a row 701a, 701b, or 701c either individually or in combination as described above with reference to FIGS. 8 and 9.

FIG. 11 is a flowchart of an implementation of a method 1100 of detecting actuation of an IMOD display element 12. At block 1102, a voltage is applied to a column electrode coupled to the IMOD display element 12 according to image data generated for display. For example, with reference to FIG. 7, in one implementation, a driver circuit 26 may be configured to drive the voltage waveform to the column electrodes. Then, the column driver is uncoupled from the column electrode(s) at block 1104. At block 1106, the column voltage is maintained on the column electrode with the current detection circuit. At block 1108, a row driver circuit 24 may be configured to drive a write waveform to a row electrode 701 to selectively actuate the IMOD display element 12. Thereafter, the row driver circuit 24 may apply a hold voltage to the row electrode 701.

At block 1110, the state of the IMOD display element 12 is detected using the voltage waveform. For example, a detection circuit 704 is configured to detect actuation of the IMOD display element 12. For example, the detection circuit 704 may be configured to detect a current induced in the column electrode 702 in response to the change in voltage in the row electrode based on the voltage waveform. In one implementation, the detection circuit 704 may be configured to integrate the current to determine the capacitance of the IMOD display element 12.

FIG. 12 is flowchart of another implementation of a method 1200 of detecting actuation of one or more IMOD display elements. The method 1200 is described in relation to FIG. 10. At block 1202, addressing voltage waveforms corresponding to image data are applied to one or more column electrodes 702a, 702b, and 702c in an IMOD array 30. For example a column driver circuit 26 may be configured to apply the addressing voltage waveforms to the column electrode 702a, 702b, and 702c during an addressing period. At block 1204, an amount of leakage current is measured in the one or more column electrodes. For example, one or more of the switches 816a, 816b, and 816c may be switched such that one or more of the column electrodes 702a, 702b, and 702c are decoupled from the column driver circuit 26 and coupled to the detection circuit 704. A leakage detection circuit (such as the leakage detection circuit 820 in FIG. 8) can be configured to determine an amount of leakage current in the one or more column electrodes 702a, 702b, and 702c.

At block 1206, a write voltage (e.g., VC_{ADD}) is applied to a row electrode 701 of the IMOD array 30. For example, a row driver circuit 24 may be configured to apply a write voltage to a row electrode 701a, 701b, and 701c to selectively trigger actuation of IMOD display elements in the array 30 based on the addressing voltage waveforms applied to the column electrodes 702a, 702b, and 702c. After the actuation period, at block 1208, a hold voltage is applied to the row electrode of the IMOD array 30. For example, the row driver circuit 24 may be configured to apply VC_{HOLD} to the row electrodes 701a, 702b, and 702c. At block 1210, an amount of current is detected in the one or more column electrodes in response to the change in voltage in the row electrode 701a. For example, the current may correspond to current induced in response to the change from the write voltage to the hold voltage. The detection circuit 704 may be configured to determine the amount of current induced. At block 1212, a capacitance of the one or more IMOD display elements in the IMOD array is determined based on the amount of current induced and compensated by the amount leakage current measured.

It should be appreciated that while some of the above described implementations describe measuring an induced current as a result of changing from VC_{ADD} to VC_{HOLD}, other changes in the addressing and write voltage waveforms may be used to detect changes in current or other electrical characteristics that may be a function of the capacitance. For example, a rising edge of the voltage waveform of the row electrode 701 from VC_{HOLD} to VC_{ADD} may be used according to some implementations. Other changes in the voltage waveform used to detect actuation while writing image data are also contemplated by implementations described herein.

FIGS. 13A and 13B are system block diagrams illustrating a display device 40 that includes a plurality of IMOD display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein.

The components of the display device 40 are schematically illustrated in FIG. 13A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 13A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A display apparatus, comprising:
an array of display elements formed at the intersections of a plurality of column electrodes and a plurality of row electrodes;
a column driver circuit configured to selectively apply at least first and second column voltages corresponding to image data to the column electrodes;
a row driver circuit configured to apply write pulses to the row electrodes to sequentially set rows of the array to states based at least in part on the voltages selectively applied to the column electrodes;
one or more switches each having an input terminal coupled to a column electrode, a first output terminal coupled to an output of the column driver circuit, and a second output terminal coupled to the first input of an integrator;
wherein the display apparatus is configured to:
selectively apply column voltages to the column electrodes corresponding to image data to be displayed while each of the one or more switches have their input terminal coupled to their first output terminal so that the column electrodes are coupled to outputs of the column driver circuit;
set the first inputs of the integrators to one of the at least first and second column voltages;
connect the input terminals of the one or more switches to the second output terminals of the one or more switches without changing the voltages on the column electrodes;
apply a write pulse to a row electrode to set the state of the display elements in accordance with the image data;
integrate a current in the column electrode produced by a trailing edge of the write pulse; and
determine a state of one or more display elements at the time of the trailing edge of the write pulse based at least in part on the current.

2. The display apparatus of claim 1, further comprising a leakage detection circuit configured to detect an amount of leakage current in the column electrode at a time prior to the leading edge of the write pulse.

3. The display apparatus of claim 1, wherein the integrator circuit includes an amplifier having an output coupled to an input via a capacitor.

4. The display apparatus of claim 3, wherein the integrator includes a reset switch connected across the capacitor.

5. The display apparatus of claim 3, wherein the display apparatus is configured to open the reset switch after the leading edge of the write pulse and before the trailing edge of the write pulse.

6. The display apparatus of claim 1, including an analog-to-digital converter coupled to an output of the integrator.

7. The display apparatus of claim 1, further comprising an array of interferometric modulator (IMOD) display elements including the display element coupled to one or more row electrodes including the row electrode and one or more column electrodes including the column electrode, wherein the driver circuit is configured to apply the voltage waveforms to the one or more row electrodes and the one or more column electrodes to control actuation of the one or more IMOD display elements, and wherein the detection circuit is configured to detect actuation of the one or more of the IMOD display elements based on the voltage waveforms.

8. The display apparatus of claim 1, further comprising:
a processor that is configured to communicate with the display, the processor being configured to process the image data; and
a memory device that is configured to communicate with the processor.

9. The apparatus of claim 8, wherein the display apparatus further includes a controller configured to send at least a portion of the image data to the driver circuit.

10. The apparatus of claim 9, further comprising:
an image source module configured to send the image data to the processor, wherein the image source module comprises at least one of a receiver, transceiver, and transmitter.

11. The apparatus of claim 9, further comprising:
an input device configured to receive input data and to communicate the input data to the processor.

12. A method of detecting the state of a display element:
applying a column voltage with a column driver circuit to a column electrode coupled to the display element according to image data generated for display;
uncoupling the column driver circuit from the column electrode;
maintaining the column voltage with a current detection circuit;
applying a write waveform including a leading edge and a trailing edge with a row driver circuit to a row electrode coupled to the display element; and
detecting the state of the display element at the trailing edge of the write waveform with the current detection circuit.

13. The method of claim 12, wherein detecting the state includes integrating a current on the column electrode generated by the trailing edge of the write waveform.

14. The method of claim 13, wherein integrating the current is indicative of a capacitance of the display element.

15. The method of claim 12, further including detecting an amount of leakage current in the column electrode.

16. The method of claim 12, wherein the display element includes an IMOD display element.

17. A display apparatus comprising:
means for applying a column voltage with a column driver circuit to a column electrode coupled to a display element according to image data generated for display;
means for uncoupling the column driver circuit from the column electrode;
means for maintaining the column voltage with a current detection circuit;
means for applying a write waveform including a leading edge and a trailing edge with a row driver circuit to a row electrode coupled to the display element; and
means for detecting the state of the display element at the trailing edge of the write waveform with the current detection circuit.

18. The display apparatus of claim 17, wherein the means for detecting the state includes means for integrating a current on the segment electrode.

19. The display apparatus of claim 17, wherein the means for uncoupling includes a switch.

20. The display apparatus of claim 17, wherein the means for maintaining includes an operational amplifier.

21. The display apparatus of claim 17, wherein the display element includes an IMOD display element.
